(19) United States
(12) Patent Application Publication
(10) Pub. No.: US 2020/0223117 A1
(43) Pub. Date: Jul. 16, 2020

(54) POLYMERIC FOAM LAYER AND METHODS OF MAKING THE SAME

(71) Applicant: 3M INNOVATIVE PROPERTIES COMPANY, St. Paul, MN (US)

(72) Inventors: Caitlin E. Meree, St. Paul, MN (US); Jeffrey P. Kalish, St. Paul, MN (US)

(21) Appl. No.: 16/650,131

(22) PCT Filed: Sep. 17, 2018
(86) PCT No.: PCT/IB2018/057120

§ 371 Date: Mar. 24, 2020

Related U.S. Application Data
(60) Provisional application No. 62/565,788, filed on Sep. 29, 2017.

(51) Int. Cl. B29C 48/00; B29C 44/50

(52) U.S. Cl. CPC B29C 48/0012; B29C 43/46; B29C 44/50

(57) ABSTRACT

Polymeric foam layer comprising a star polymer, wherein the polymeric foam layer has a thickness up to 25,700 micrometers, and methods of making the same. Exemplary uses of polymeric foam layers described herein including a finishing pad for silicon wafers and vibration damping.

### CROSS REFERENCE TO RELATED APPLICATION

This application claims the benefit of U.S. Provisional patent application Ser. No. 62/565,788, filed

Sep. 29, 2017, the disclosure of which is incorporated by reference herein in its entirety.

### BACKGROUND

Foam products are commonly made by injection molding or by forming a large block of foam and then cutting the block into sheets. Converting processes such as convoluted cutting, hot wire, machining and contour cutting is commonly used to provide shapes on surfaces of the sheets. Such shaped surfaces typically exhibit open cells.

Another common approach to making shaped foam is to cast a foamed film onto a casting roll to create a smooth surface foamed film. To create three-dimensional features, the film can be embossed, thereby compressing sections of the film. The cells in the compressed areas are crushed, permanently damaging the cell structure.

A third approach to making shaped foam is by profile extrusion, wherein foamed polymer is extruded through a profile die having the desired contour shape cut in the die. The resulting contoured foam shape is continuous in the down web direction. Uses of such shaped foams include gasket seals.

Alternative polymeric foams and/or methods for making polymeric foams are desired.

### SUMMARY

In one aspect, the present disclosure describes a polymeric foam layer comprising a star polymer, wherein the polymeric foam layer has a thickness up to 25,700 micrometers (in some embodiments, in a range from 100 micrometers to 1000 micrometers, 1000 micrometers to 6000 micrometers, 6000 micrometers to 12,700 micrometers or even 12,700 micrometers to 25,400 micrometers).

In another aspect, the present disclosure describes a first method of making a polymeric foam layer described herein, the method comprising:

providing a rotating tool roll having a major circumferential surface and an extrusion die with a die lip spaced in proximity of the tool roll to form a gap between the tool roll and the extrusion die; and

introducing a star polymer comprising a foaming agent onto a portion of the major circumferential surface of the tool roll, wherein of the portion of the major circumferential surface is in proximity of the die lip to provide the star polymeric foam layer.

In another aspect, the present disclosure describes a second method of making a polymeric foam layer described herein, the method comprising:

providing a rotating tool roll having a major circumferential surface and an extrusion die with a die lip spaced in proximity of the tool roll to form a gap between the tool roll and the extrusion die; and

introducing a star polymer comprising a gas onto a portion of the major circumferential surface of the tool roll, wherein of the portion of the major circumferential surface is in proximity of the die lip, wherein a gas is injected into the star polymer at least one of prior to or during contact of the star polymer with the portion of the major circumferential surface of the tool roll and, wherein the star polymer foams to provide the polymeric foam layer.

In another aspect, the present disclosure describes a third method of making a polymeric foam layer described herein, the method comprising:

providing a rotating tool roll having a major circumferential surface and an extrusion die with a die lip spaced in proximity of the tool roll to form a gap between the tool roll and the extrusion die; and

introducing a star polymer comprising polymeric microspheres onto a portion of the major circumferential surface of the tool roll, wherein the portion of the major circumferential surface is in proximity of the die lip and wherein the star polymer foams to provide the polymeric foam layer.

In another aspect, the present disclosure describes a fourth method of making a polymeric foam layer described herein, the method comprising:

providing a rotating tool roll having a major circumferential surface;

providing an extrusion die with a die lip spaced in proximity of the tool roll to form a gap between the tool roll and the extrusion die;

providing a compression roll in proximity of the tool roll to form a gap between the tool roll and the compression roll;

injecting oil into a star polymer comprising at least one of a foaming agent, a gas, or polymeric microspheres in an extrusion chamber; and

extruding the star polymer into the gap between the extrusion die and the tool roll, wherein the star polymer foams to provide the polymeric foam layer.

Exemplary uses of polymeric foam layers described herein including vibration damping and polishing applications (e.g., polishing pads useful in chemical mechanical planarization (CMP)).

### BRIEF DESCRIPTION OF THE DRAWINGS

FIG. 1 is an exemplary apparatus for the first method of making a polymeric foam layer described herein.

FIG. 2 is an exemplary apparatus for the second method of making a polymeric foam layer described herein.

FIG. 3 is an exemplary apparatus for the third method of making a polymeric foam layer described herein.

FIG. 4 is an exemplary apparatus for the fourth method of making a polymeric foam layer described herein.

### DETAILED DESCRIPTION

Exemplary star polymers include styrene isoprene styrene (SIS), styrene ethylene propylene styrene (SEPS), styrene ethylene butadiene styrene (SEBS), or styrene butadiene styrene (SBS) (including mixtures thereof). Suitable star polymers are available, for example, under the trade designation “KRATON” from Kraton, Houston, TX.

In some embodiments, polymeric foam layers described herein have a glass transition temperature, T_{g}, in a range from −125° C. to 150° C. (in some embodiments, in a range from −125° C. to −10° C., −10° C. to 80° C., 50° C. to 150° C. or even 50° C. to 80° C.). The glass transition temperature is determined as follows, using a differential scanning calorimeter (DSC) available under the trade designation “Q2000 DSC” from TA Instruments, New Castle, DE. The DSC procedure is as follows: cool sample to −180° C., temperature ramp at 10° C. /min. to 300° C. The glass transition temperature is recorded as the inflection point in the heat flow versus temperature curve.

In some embodiments, polymeric foam layers described herein can be wrapped around a 1 m (in some embodiments, 75 cm, 50 cm, 25 cm, 10 cm, 5 cm, 1 cm, 5 mm, or even 1 mm) diameter rod without breaking.

In some embodiments, polymeric foam layers described herein have first and second opposed major surfaces, and comprising foam features extending from or into the first major surface by at least 100 (in some embodiments, in a range from 100 to 1000, 1000 to 6000, 6000 to 12,700 or even 12,700 to 25,400) micrometers. In some embodiments, the features comprise at least one of the following shapes: a cone, a cube, a pyramid, a continuous rail, continuous multi-directional rails, a hemisphere, a cylinder, or a multi-lobed cylinder. In some embodiments, the features have a cross-section in at least one of the following shapes: a circle, a square, a rectangle, a triangle, a pentagon, other polygon, a sinusoidal, a herringbone, or a multi-lobe.

In some embodiments, polymeric foam layers described herein have porosity therein having an average cell size (i.e., pore size) in a range from 10 to 3000 (in some embodiments, 10 to 2000, 10 to 1000, 10 to 500, or even 10 to 100) micrometers.

In some embodiments, polymeric foam layers described herein have a total porosity of at least 5 (in some embodiments, at least 10, 20, 25, 30, 40, 50, 60, or even at least 70; in some embodiments, in a range from 10 to 70, 10 to 60, or even 10 to 50) percent, based on the total volume of the polymeric foam layer.

In some embodiments, polymeric foam layers described herein comprise a reinforcement material (e.g., a woven, nonwoven, fibers, a mesh, or a film).

In some embodiments, polymeric foam layers described herein comprise at least one of glass beads, glass bubbles, glass fibers, abrasive grain, carbon black, carbon fibers, diamond particles, composite particles, nanoparticles, mineral oil, tackifier, wax nanoparticles, rubber particles or flame retardant.

In some embodiments, polymeric foam layers described herein comprise a thermal conductive material (e.g., BN).

The first method of making a polymeric foam layer described herein comprises:

providing a rotating tool roll having a major circumferential surface and an extrusion die with a die lip spaced in proximity of the tool roll to form a gap between the tool roll and the extrusion die; and

introducing a star polymer comprising a foaming agent onto a portion of the major circumferential surface of the tool roll, wherein of the portion of the major circumferential surface is in proximity of the die lip to provide the star polymeric foam layer.

In some embodiments of the first method, the major circumferential surface of the compression roll comprises an array of cavities. In some embodiments of the first method, the major circumferential surface of the tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the first method for making polymeric foam layers described herein, the foaming agent comprises at least one of an acid (e.g., citric acid), a bicarbonate, an azodicarbonamide, a modified azodicarbonamide, a hydrazide, a sodium bicarbonate and citric acid blend, a dinitrosopentamethylenetetramine, p-toluenesulfonyl hydrazide, 4-4′-oxybis hydrazide, azodicarbonamide, p-toluenesulfonyl semicarbazide, 5-phenyltetrazole, a 5-phenyltetrazole analogue, diisopropylhydrazodicarboxylate, 5-phenyl-3,6-dihydro-1,3,4-oxadiazin-2-one, or sodium borohydride.

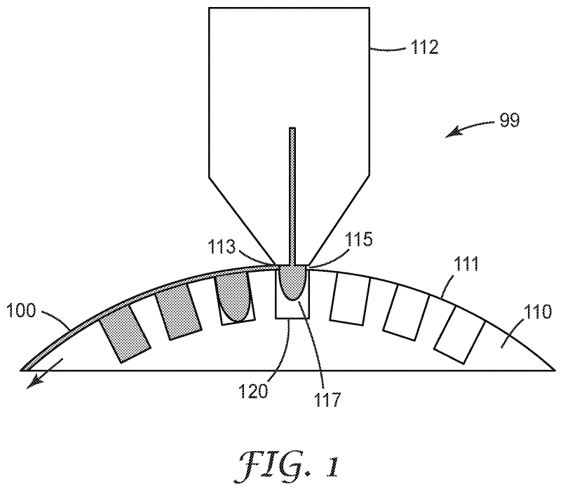

Referring to FIG. 1, apparatus 99 has rotating tool roll 110 having major circumferential surface 111 and extrusion die 112 with die lip 113 spaced in proximity of tool roll 110 to form gap 115 between tool roll 110 and extrusion die 112. Star polymer 117 comprising a foaming agent is injected onto portion 120 of major circumferential surface 111 of tool roll 110. Portion 120 of major circumferential surface 111 is in proximity of die lip 113 to provide star polymeric foam layer 100.

The second method of making a polymeric foam layer described herein, the method comprising:

providing a rotating tool roll having a major circumferential surface and an extrusion die with a die lip spaced in proximity of the tool roll to form a gap between the tool roll and the extrusion die; and

introducing a star polymer comprising a gas onto a portion of the major circumferential surface of the tool roll, wherein of the portion of the major circumferential surface is in proximity of the die lip, wherein a gas is injected into the star polymer at least one of prior to or during contact of the star polymer with the portion of the major circumferential surface of the tool roll and, wherein the star polymer foams to provide the polymeric foam layer.

In some embodiments of the second method for making polymeric foam layers described herein, the major circumferential surface of the tool roll comprises an array of cavities. In some embodiments of the second method, the major circumferential surface of the tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and multi-lobed cylinders. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the second method for making polymeric foam layers described herein, the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).

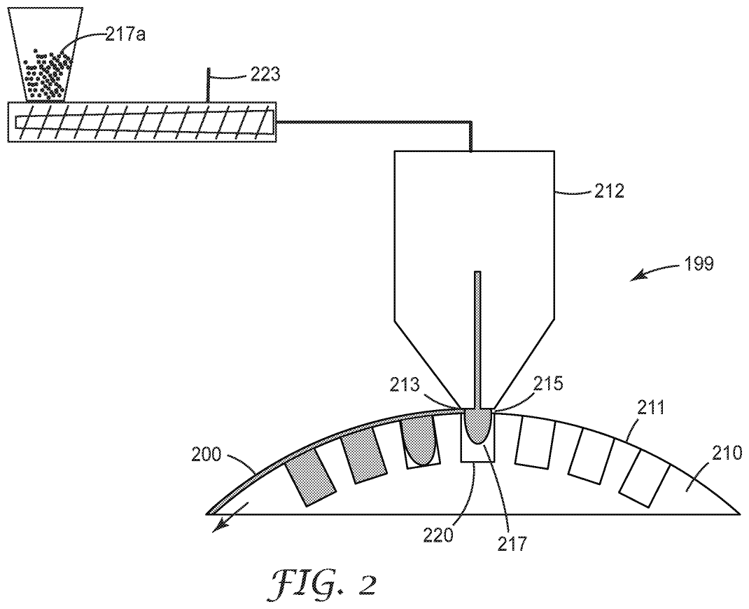

Referring to FIG. 2, apparatus 199 has rotating tool roll 210 having major circumferential surface 211 and extrusion die 212 with die lip 213 spaced in proximity of tool roll 210 to form gap 215 between tool roll 210 and extrusion die 212. Star polymer 217 comprising a gas is injected onto portion 220 of major circumferential surface 211 of tool roll 210. Portion 220 of major circumferential surface 211 is in proximity of die lip 213. Gas 223 is injected into star polymer 217a at least one of prior to or during contact of star polymer 217 with portion 220 of major circumferential surface 211 of tool roll 210. Star polymer 217 foams to provide polymeric foam layer 200.

In another aspect, the present disclosure describes a third method of making a polymeric foam layer described herein, the method comprising:

providing a rotating tool roll having a major circumferential surface and an extrusion die with a die lip spaced in proximity of the tool roll to form a gap between the tool roll and the extrusion die; and

introducing a star polymer comprising polymeric microspheres onto a portion of the major circumferential surface of the tool roll, wherein the portion of the major circumferential surface is in proximity of the die lip and wherein the star polymer foams to provide the polymeric foam layer.

In some embodiments of the third method for making polymeric foam layers described herein, the major circumferential surface of the tool roll comprises an array of cavities. In some embodiments of the third method, the major circumferential surface of the tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and multi-lobed cylinders. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the third method for making polymeric foam layers described herein, the polymeric microspheres comprise expanding bubbles. Exemplary expanding bubbles are available, for example, under the trade designation “EXPANCEL” from AkzoNobel, Amsterdam, Netherlands or “DUALITE” from Chase Corporation, Westwood, Mass.

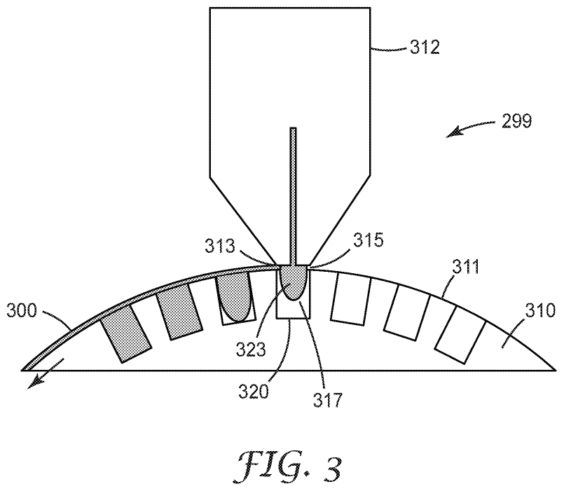

Referring to FIG. 3, apparatus 299 has rotating tool roll 310 having major circumferential surface 311 and extrusion die 312 with die lip 313 spaced in proximity of tool roll 310 to form gap 315 between tool roll and extrusion die 312. Star polymer 317 comprising polymeric microspheres onto portion 320 of major circumferential surface 311 of tool roll 310. Portion 320 of major circumferential surface 311 is in proximity of die lip 312. Star polymer 317 foams to provide polymeric foam layer 300.

The fourth method of making a polymeric foam layer described herein, the method comprising:

providing a rotating tool roll having a major circumferential surface and compression roll in proximity of the tool roll to form a gap between the tool roll and the compression roll;

injecting oil into a star polymer comprising at least one of a foaming agent, a gas, or polymeric microspheres in an extrusion chamber; and

extruding the star polymer into the gap, wherein the star polymer foams to provide the polymeric foam layer.

In some embodiments of the fourth method for making polymeric foam layers described herein, the major circumferential surface of the tool roll comprises an array of cavities. In some embodiments of the fourth method, the major circumferential surface of the tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and multi-lobed cylinders. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the fourth method for making polymeric foam layers described herein, further comprising a compression roll having a major circumferential surface positioned near the extrusion die, downweb.

In some embodiments of the fourth method for making polymeric foam layers described herein, the oil comprises at least one of a lanolin, a liquid polyacrylate, a liquid polybutene, a mineral oil, or a phthalate.

In some embodiments of the fourth method for making polymeric foam layers described herein, the foaming agent comprises at least one of an acid, bicarbonate, an azodicarbonamide, a modified azodicarbonamide, a hydrazide, a sodium bicarbonate and citric acid blend, dinitrosopentamethylenetetramine, p-toluenesulfonyl hydrazide, 4-4′-oxybis hydrazide, azodicarbonamide, p-toluenesulfonyl semicarbazide, 5-phenyitetrazole, a 5-phenyltetrazole analogue, diisopropylhydrazodicarboxylate, 5-phenyl-3,6-dihydro-1,3,4-oxadiazin-2-one, or sodium borohydride.

In some embodiments of the fourth method for making polymeric foam layers described herein, the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).

In some embodiments of the fourth method for making polymeric foam layers described herein, the polymeric microspheres comprise expanding bubbles. Exemplary expanding bubbles are available, for example, under the trade designations “EXPANEL” from AkzoNobel, or “DUALITE” from Chase Corporation.

In some embodiments of the fourth method for making polymeric foam layers described herein, the oil is at a temperature greater than 80° C. (in some embodiments, at least 90° C., 100° C., 125° C., 150° C., 175° C., or even, at least 200° C.; in some embodiments, in a range from 80° C. to 250° C., 100° C. to 250° C., or even 100° C. to 200° C.).

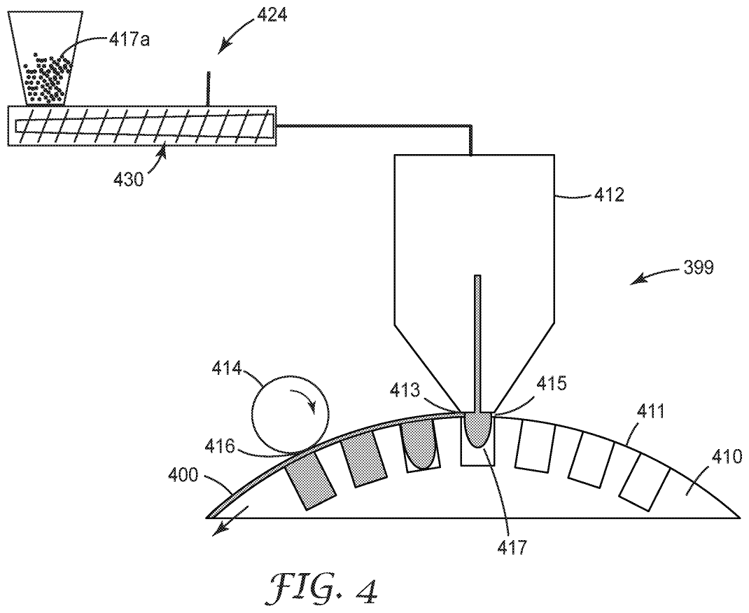

Referring to FIG. 4, apparatus 399 has rotating tool roll 410 having major circumferential surface 411, extrusion die 412 with die lip 413 spaced in proximity of tool roll 410 to form gap 415 between tool roll 410 and extrusion die 412. Compression roll 414 in proximity of tool roll 410 to form gap 416 between tool roll 410 and compression roll 414. Oil 424 is injected into star polymer 417a comprising at least one of a foaming agent, a gas, or polymeric microspheres in extrusion chamber 430. Polymer 417 is extruded into gap 415. Polymer 417 foams to provide polymeric foam layer described herein 400.

The present disclosure also described a method of providing an article, the method comprising;

providing a polymeric foam layer of any A Exemplary Embodiment;

and applying at least one of heat or pressure to permanently deform at least one protrusion of the polymeric foam layer.

The apparatus can be made of conventional materials and techniques known in the art for apparatuses of these general types.

Exemplary uses of polymeric foam layers described herein including vibration damping and polishing applications (e.g., polishing pads useful in chemical mechanical planarization (CMP)).

### EXEMPLARY EMBODIMENTS

1A. A polymeric foam layer comprising a star polymer, wherein the polymeric foam layer has a thickness up to 25,700 (in some embodiments, in a range from 100 to 1000, 1000 to 6000 micrometers, 6000 to 12,700 or even 12,700 to 25,400) micrometers.

2A. The polymeric foam layer of Exemplary Embodiment 1A, wherein the star polymer comprises at least one of styrene isoprene styrene (SIS), styrene ethylene propylene styrene (SEPS), styrene ethylene butadiene styrene (SEBS), or styrene butadiene styrene (SBS).

3A. The polymeric foam layer of any preceding A Exemplary Embodiment having a glass transition temperature, T_{g}, in a range from −125° C. to 150° C. (in some embodiments, in a range from −125° C. to −10° C., −10° C. to 80° C., 50° C. to 150° C. or even 50° C. to 80° C.).

4A. The polymeric foam layer of any of preceding A Exemplary Embodiment that can be wrapped around a 1 m (in some embodiments, 75 cm, 50 cm, 25 cm, 10 cm, 5 cm, 1 cm, 5 mm, or even 1 mm) diameter rod without breaking.

5A. The polymeric foam layer of any preceding A Exemplary Embodiment having first and second opposed major surfaces, and comprising foam features extending from or into the first major surface by at least 100 (in some embodiments, in a range from 100 to 1000, 1000 to 6000, 6000 to 12,700 or even 12,700 to 25,400) micrometers.

6A. The polymeric foam layer of Exemplary Embodiment 5A, wherein the features comprise at least one of the following shapes: a cone, a cube, a pyramid, a continuous rail, continuous multi-directional rails, a hemisphere, a cylinder, or a multi-lobed cylinder.

7A. The polymeric foam layer of Exemplary Embodiment 5A, wherein the features have a cross-section in at least one of the following shapes: a circle, a square, a rectangle, a triangle, a pentagon, other polygon, a sinusoidal, a herringbone, or a multi-lobe.

8A. The polymeric foam layer of any preceding A Exemplary Embodiment having porosity therein having an average cell size (i.e., pore size) in a range from 10 to 3000 (in some embodiments, 10 to 200, 10 to 1000, 10 to 5000, or even 10 to 1000) micrometers.

9A. The polymeric foam layer of any preceding A Exemplary Embodiment having a total porosity of at least 5 (in some embodiments, at least 10, 20, 25, 30, 40, 50, 60, or even at least 70; in some embodiments, in a range from 10 to 70, 10 to 60, or even 10 to 50) percent, based on the total volume of the polymeric foam layer.

10A. The polymeric foam layer of any preceding A Exemplary Embodiment comprising a reinforcement material (e.g., a woven, nonwoven, fibers, a mesh, or a film).

11A. The polymeric foam layer of any preceding A Exemplary Embodiment comprising at least one of glass beads, glass bubbles, glass fibers, abrasive grain, carbon black, carbon fibers, diamond particles, composite particles, nanoparticles, mineral oil, tackifier, wax nanoparticles, rubber particles or flame retardant.

12A. The polymeric foam layer of any preceding A Exemplary Embodiment comprising a thermal conductive material (e.g., BN).

1B. A method of making a polymeric foam layer, the method comprising:

providing a rotating tool roll having a major circumferential surface and an extrusion die with a die lip spaced in proximity of the tool roll to form a gap between the tool roll and the extrusion die; and

introducing a star polymer comprising a foaming agent onto a portion of the major circumferential surface of the tool roll, wherein the portion of the major circumferential surface is in proximity of the die lip to provide the star polymeric foam layer of any preceding A Exemplary Embodiment.

2B. The method of Exemplary Embodiment 1B, wherein the major circumferential surface of the tool roll comprises an array of cavities.

3B. The method of any preceding B Exemplary Embodiment, wherein the major circumferential surface of the compression roll comprises an array of cavities.

4B. The method of any preceding B Exemplary Embodiment, wherein the major circumferential surface of the tool roll comprises an array of protrusions.

5B. The method of any preceding B Exemplary Embodiment, wherein the foaming agent comprises at least one of an acid, a bicarbonate, an azodicarbonamide, a modified azodicarbonamide, a hydrazide, a sodium bicarbonate and citric acid blend, a dinitrosopentamethylenetetramine, p-toluenesulfonyl hydrazide, 4-4′-oxybis hydrazide, azodicarbonamide, p-toluenesulfonyl semicarbazide, 5-phenyltetrazole, a 5-phenyltetrazole analogue, diisopropylhydrazodicarboxylate, 5-phenyl-3,6-dihydro-1,3,4-oxadiazin-2-one, or sodium borohydride.

1C. A method of making a polymeric foam layer, the method comprising:

providing a rotating tool roll having a major circumferential surface and an extrusion die with a die lip spaced in proximity of the tool roll to form a gap between the tool roll and the extrusion die; and

introducing a star polymer comprising a gas onto a portion of the major circumferential surface of the tool roll, wherein the portion of the major circumferential surface is in proximity of the die lip, wherein a gas is injected into the star polymer at least one of prior to or during contact of the star polymer with the portion of the major circumferential surface of the tool roll and, wherein the star polymer foams to provide the polymeric foam layer of any preceding A Exemplary Embodiment.

2C. The method of Exemplary Embodiment 1C, wherein the major circumferential surface of the tool roll comprises an array of cavities.

3C. The method of any preceding C Exemplary Embodiment, wherein the major circumferential surface of the tool roll comprises an array of protrusions.

4C. The method of any preceding C Exemplary Embodiment, wherein the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).

1D. A method of making a polymeric foam layer, the method comprising:

providing a rotating tool roll having a major circumferential surface and an extrusion die with a die lip spaced in proximity of the tool roll to form a gap between the tool roll and the extrusion die; and

introducing a star polymer comprising polymeric microspheres onto a portion of the major circumferential surface of the tool roll, wherein of the portion of the major circumferential surface is in proximity of the die lip and wherein the star polymer foams to provide the polymeric foam layer of any preceding A Exemplary Embodiment.

2D. The method of Exemplary Embodiment 1D, wherein the major circumferential surface of the tool roll comprises an array of cavities.

3D. The method of any preceding D Exemplary Embodiment, wherein the major circumferential surface of the tool roll comprises an array of protrusions.

4D. The method of any preceding D Exemplary Embodiment, wherein the polymeric microspheres comprise expanding bubbles.

1E. A method of making a polymeric foam layer, the method comprising:

providing a rotating tool roll having a major circumferential surface;

providing an extrusion die with a die lip spaced in proximity of the tool roll to form a gap between the tool roll and the extrusion die;

providing a compression roll in proximity of the tool roll to form a gap between the tool roll and the compression roll;

injecting oil into a star polymer comprising at least one of a foaming agent, a gas, or polymeric microspheres in an extrusion chamber; and

extruding the star polymer into the gap between the extrusion die and the tool roll, wherein the star polymer foams to provide the polymeric foam layer of any preceding A Exemplary Embodiment.

2E. The method of Exemplary Embodiment 1E, wherein the major circumferential surface of the tool roll comprises an array of cavities.

3E. The method of any preceding E Exemplary Embodiment, wherein the major circumferential surface of the tool roll comprises an array of protrusions.

4E. The method of any preceding E Exemplary Embodiment further comprising a compression roll having a major circumferential surface positioned near the extrusion die, downweb.

5E. The method of Exemplary Embodiment 4E, wherein the major circumferential surface of the compression roll comprises an array of cavities.

6E. The method of either Exemplary Embodiment 4E or 5E, wherein the major circumferential surface of the compression roll comprises an array of protrusions.

7E. The method of any preceding E Exemplary Embodiment, wherein the oil comprises at least one of a lanolin, a liquid polyacrylate, a liquid polybutene, a mineral oil, or a phthalate.

8E. The method of any preceding E Exemplary Embodiment, wherein the foaming agent comprises at least one of an acid, bicarbonate, an azodicarbonamide, a modified azodicarbonamide, a hydrazide, a sodium bicarbonate and citric acid blend, dinitmsopentamethylenetetramine, p-toluenesulfonyl hydrazide, 4-4′-oxybis hydrazide, azodicarbonamide, p-toluenesulfonyl semicarbazide, 5-phenyltetrazole, a 5-phenyitetrazole analogue, diisopropylhydrazodicarboxylate, 5-phenyl-3,6-dihydro-1,3,4-oxadiazin-2-one, or sodium borohydride.

9E. The method of any preceding E Exemplary Embodiment, wherein the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).

10E. The method of any preceding E Exemplary Embodiment, wherein the polymeric microspheres comprise expanding bubbles.

11E. The method of any preceding E Exemplary Embodiment, wherein the oil is at a temperature greater than 80° C. (in some embodiments, at least 90° C., 100° C., 125° C., 150° C., 175° C., or even, at least 200° C.; in some embodiments, in a range from 80° C. to 250° C., 100° C. to 250° C., or even 100° C. to 200° C.).

1F. A method of providing an article, the method comprising;

providing a polymeric foam layer of any A Exemplary Embodiment; and applying at least one of heat or pressure to permanently deform at least one protrusion of the polymeric foam layer.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example 1

Example 1 was made using an apparatus as generally shown in FIG. 1. The extrusion die was 20.3 cm (8 inches) wide (obtained under the trade designation “MASTERFLEX” (Model LD-40) from Cloeren, Orange, Tex.) configured with the die positioned on the top of the tool roll at top dead center. The die was orientated such that the bottom of the die was on the trailing edge of the tooling roll. The bottom die lip had a 3.18 mm (0.125 inch) land. The extruder was a 6.35 cm (2.5 inch) single screw extruder (obtained from Davis-Standard, Pawcatuck, CT). The die temperature set points used are shown in the Table, below.

TABLE

| Heating | Extruder, | Extrusion Die, |
|---|---|---|
| Zones | ° C. (° F.) | ° C. (° F.) |
| Zone 1 | 149 (300) | 171 (340) |
| Zone 2 | 160 (320) | 171 (340) |
| Zone 3 | 171 (340) | 171 (340) |
| Zone 4 | 171 (340) | |
| End cap | 171 (340) | |
| Neck Tube | 171 (340) | |
| Extruder RPM | 6 | |

A single tooling roll station was used with the die mounted at the top dead center of the roll. The die was mounted on linear slides to move in the up and down direction. The roll was nominally 30.5 cm (12 inch) in diameter with a 40.6 cm (16 inch) face width. The tooling roll has internal water cooling with spiral wound internal channels. A 33.6 cm (13.25 inch) outside diameter silicone tooling shell was mounted onto the outer surface of the roll.

The linear motion of the die was controlled by linear actuators to move the die and to control the gap between the die lip and tooling roll. The tooling roll had through holes drilled through the silicone shell. The straight holes were 3 mm (0.118 inch) in diameter at the surface. The holes were spaced 5 mm (0.2 inch) apart on center in both directions. The tooling roll was set with a cooling temperature set point of 15.6° C. (60° F). The gap between the die lip and the tool roll surface was set at 508 micrometers (0.020 inch). The line speed was 0.53 meter (1.75 feet) per minute.

A polymer was manually premixed prior to being fed into the extruder. The polymer was a resin blend of 68 percent by weight block co-polymer elastomer (obtained under the trade designation “KRATON 1161” from Kraton, Houston, Tex.), 27 percent by weight block co-polymer elastomer (obtained under the trade designation “KRATON DL12340” from Kraton) and 5 percent by weight blowing agent (obtained under the trade designation “ECOCELL H” from Polyfil Corporation, Rockaway, N.J.).

A polymeric foam layer was produced with protrusions extending from the surface with the protrusion spacing and height matching the tooling roll pattern.

Foreseeable modifications and alterations of this disclosure will be apparent to those skilled in the art without departing from the scope and spirit of this invention. This invention should not be restricted to the embodiments that are set forth in this application for illustrative purposes.

1. A polymeric foam layer comprising a star polymer, wherein the polymeric foam layer has a thickness up to 25,700 micrometers.

2. The polymeric foam layer of claim 1, wherein the star polymer comprises at least one of styrene isoprene styrene, styrene ethylene propylene styrene, styrene ethylene butadiene styrene, or styrene butadiene styrene.

3. The polymeric foam layer claim 1, having a glass transition temperature, T_{g}, in a range from −125° C. to 150° C.

4. The polymeric foam layer of claim 1 having first and second opposed major surfaces, and comprising foam features extending from or into the first major surface by at least 100 micrometers.

5. A method of making a polymeric foam layer, the method comprising:
providing a rotating tool roll having a major circumferential surface and an extrusion die with a die lip spaced in proximity of the tool roll to form a gap between the tool roll and the extrusion die; and
introducing a star polymer comprising a foaming agent onto a portion of the major circumferential surface of the tool roll, wherein the portion of the major circumferential surface is in proximity of the die lip to provide the star polymeric foam layer of claim 1.

6. A method of making a polymeric foam layer, the method comprising:
providing a rotating tool roll having a major circumferential surface and an extrusion die with a die lip spaced in proximity of the tool roll to form a gap between the tool roll and the extrusion die; and
introducing a star polymer comprising a gas onto a portion of the major circumferential surface of the tool roll, wherein the portion of the major circumferential surface is in proximity of the die lip, wherein a gas is injected into the star polymer at least one of prior to or during contact of the star polymer with the portion of the major circumferential surface of the tool roll and, wherein the star polymer foams to provide the polymeric foam layer of claim 1.

7. A method of making a polymeric foam layer, the method comprising:
providing a rotating tool roll having a major circumferential surface and an extrusion die with a die lip spaced in proximity of the tool roll to form a gap between the tool roll and the extrusion die; and
introducing a star polymer comprising polymeric microspheres onto a portion of the major circumferential surface of the tool roll, wherein the portion of the major circumferential surface is in proximity of the die lip and wherein the star polymer foams to provide the polymeric foam layer of claim 1.

8. A method of making a polymeric foam layer, the method comprising:
providing a rotating tool roll having a major circumferential surface;
providing an extrusion die with a die lip spaced in proximity of the tool roll to form a gap between the tool roll and the extrusion die;
providing a compression roll in proximity of the tool roll to form a gap between the tool roll and the compression roll;
injecting oil into a star polymer comprising at least one of a foaming agent, a gas, or polymeric microspheres in an extrusion chamber; and
extruding the star polymer into the gap between the extrusion die and the tool roll, wherein the star polymer foams to provide the polymeric foam layer of claim 1.

9. The method of claim 8, further comprising a compression roll having a major circumferential surface positioned near the extrusion die, downweb.

10. The method of claim 9, wherein the major circumferential surface of the compression roll comprises an array of cavities.

11. The method of claim 9, wherein the major circumferential surface of the compression roll comprises an array of protrusions.
